(19) United States
(12) Patent Application Publication
(10) Pub. No.: US 2022/0028102 A1
(43) Pub. Date: Jan. 27, 2022

(54) DEVICES AND METHODS FOR DETERMINING CONFIDENCE IN STEREO MATCHING USING A CLASSIFIER-BASED FILTER

(71) Applicant: Facebook Technologies, LLC, Menlo Park, CA (US)

(72) Inventors: Rajesh Lachhmandas CHHABRIA, San Jose, CA (US); Shuochen SU, Bellevue, WA (US)

(21) Appl. No.: 17/074,495

(22) Filed: Oct. 19, 2020

Related U.S. Application Data
(60) Provisional application No. 63/057,151, filed on Jul. 27, 2020.

(51) Int. Cl. G06T 7/593

(52) U.S. Cl. CPC G06T 7/593; H04N 13/128; G06T 2207/10012; G06T 2207/20084

(57) ABSTRACT

A method of determining confidence in stereo matching includes receiving left image information; receiving right image information; determining a stereo matching difference profile between the left image information and the right image information; and determining one or more confidence values of stereo matching consistency by applying a predefined classifier to the stereo matching difference profile. Associated electronic devices and computer readable storage media are also disclosed.

### RELATED APPLICATIONS

This application claims the benefit of, and priority to, U.S. Provisional Patent Application Ser. No. 63/057,151, filed Jul. 27, 2020, which is incorporated by reference herein in its entirety.

### TECHNICAL FIELD

This application relates generally to image processing devices, and more specifically to image processing devices for stereo matching.

### BACKGROUND

Mobile display devices are widely used for collecting and providing visual information to a user. For example, mobile phones are used for taking photographs and recording videos. Head-mounted display devices are gaining popularity for their ability to provide virtual reality and augmented reality information.

Depth sensing is an important technique for various applications, such as camera operations (e.g., taking photographs and recording videos), virtual reality and augmented reality operations, and security applications (e.g., face recognition, etc.). In addition, determining the reliability of the depth information is important for reliable operation of devices using depth sensing techniques.

However, conventional methods for determining the reliability of the depth information require significant computational resources, and thus, their applications in mobile display devices have been limited.

### SUMMARY

Accordingly, there is a need for devices and methods that can determine the reliability of the depth information.

The devices and methods disclosed in this application use a predefined classifier that can streamline determination of the reliability of stereo matching, which is associated with the reliability of the determined depth information. Such predefined classifier eliminates the need for various operations required in conventional methods, such as left-right consistency check. Thus, the disclosed methods and devices can provide the reliability information faster while using less computational resources and energy.

In accordance with some embodiments, a method of determining confidence in stereo matching includes receiving left image information; receiving right image information; determining a stereo matching difference profile between the left image information and the right image information; and determining one or more confidence values of stereo matching consistency by applying a predefined classifier to the stereo matching difference profile.

In accordance with some embodiments, an electronic device includes one or more processors and memory storing instructions for execution by the one or more processors. The stored instructions include instructions for receiving left image information; receiving right image information; determining a stereo matching difference profile between the left image information and the right image information; and determining one or more confidence values of stereo matching consistency by applying a predefined classifier to the stereo matching difference profile.

In accordance with some embodiments, a computer readable storage medium stores instructions, which, when executed by one or more processors of an electronic device, cause the electronic device to: receive left image information; receive right image information; determine a stereo matching difference profile between the left image information and the right image information; and determine one or more confidence values of stereo matching consistency by applying a predefined classifier to the stereo matching difference profile.

The disclosed methods and devices may replace, or complement, conventional methods and devices for determining the reliability in stereo matching.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIGS. 1A and 1B are diagrams of an example of a near-eye display in accordance with some embodiments.

FIG. 2 is an example of a cross section of the near-eye display in accordance with some embodiments.

FIG. 3 illustrates an isometric view of an example of a waveguide display with a single source assembly in accordance with some embodiments.

FIG. 4 illustrates a cross section of an example of the waveguide display in accordance with some embodiments.

FIG. 5A is a block diagram of an example of a system including the near-eye display in accordance with some embodiments.

FIG. 5B is a schematic diagram illustrating imaging device and an illumination source for stereoscopic imaging, in accordance with some embodiments.

FIG. 6A is a schematic diagram illustrating images obtained by a stereoscopic imaging device in accordance with some embodiments.

FIG. 6B is a schematic diagram illustrating stereo matching operations in accordance with some embodiments.

FIG. 6C is a schematic diagram illustrating operations for a left-right consistency check in accordance with some embodiments.

FIG. 7A is a schematic diagram illustrating operations for determining confidence in stereo matching in accordance with some embodiments.

FIG. 7B illustrates a curve used for obtaining a distance to an object based on disparity between two images in accordance with some embodiments.

FIG. 7C illustrates filtering depth information based on the confidence in the depth information in accordance with some embodiments.

FIG. 8A illustrates components of a device that determines confidence in stereo matched images based on left-right consistency check in accordance with some embodiments.

FIG. 8B illustrates components of a device that determines confidence in stereo matched images using a classifier in accordance with some embodiments.

FIG. 8C illustrates components of a device that includes both the confidence estimator shown in FIG. 8A and the confidence estimator shown in FIG. 8B, in accordance with some embodiments.

FIG. 9 is a flow diagram illustrating a method of determining confidence in stereo matching in accordance with some embodiments.

The figures depict examples of the present disclosure for purposes of illustration only. One skilled in the art will readily recognize from the following description that alternative examples of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive examples. However, it will be apparent that various examples may be practiced without these specific details. The figures and description are not intended to be restrictive.

In some cases, depth sensing involves determining a depth (or a depth map) from one or more images. The images are collected using an image sensor.

A typical image sensor includes an array of pixel cells. Each pixel cell includes a photodiode to measure the intensity of incident light by converting photons into charge (e.g., electrons or holes). The charge generated by the photodiode can be converted to a voltage by a charge sensing unit, which can include a floating drain node. The voltage can be quantized by an analog-to-digital converter (ADC) into a digital value. The digital value can represent an intensity of light received by the pixel cell and can form a pixel, which can correspond to light received from a spot of a scene. An image comprising an array of pixels can be derived from the digital outputs of the array of pixel cells.

An image sensor can be used to perform different modes of imaging, such as 2D and 3D sensing. The 2D and 3D sensing can be performed based on light of different wavelength ranges. For example, light within a visible wavelength range can be used for 2D sensing, whereas light outside the visible wavelength range (e.g., infrared light) can be used for 3D sensing. An image sensor may include an optical filter array to allow light of different visible wavelength ranges and colors (e.g., red, green, blue, monochrome, etc.) to reach a first set of pixel cells assigned for 2D sensing, and to allow light of the invisible wavelength range to a second set of pixel cells assigned for 3D sensing.

To perform 2D sensing, a photodiode of a pixel cell can generate charge at a rate that is proportional to an intensity of visible light component (e.g., red, green, blue, monochrome, etc.) incident upon the pixel cell, and the quantity of charge accumulated in an exposure period can be used to represent the intensity of visible light (or a certain color component of the visible light). The charge can be stored temporarily at the photodiode and then transferred to a capacitor (e.g., a floating diffusion) to develop a voltage. The voltage can be sampled and quantized by an analog-to-digital converter (ADC) to generate an output corresponding to the intensity of visible light. An image pixel value can be generated based on the outputs from multiple pixel cells configured to sense different color components of the visible light (e.g., red, green, and blue colors).

Moreover, to perform 3D sensing, light of a different wavelength range (e.g., infrared light) can be projected onto an object, and the reflected light can be detected by the pixel cells. The light can include structured light, light pulses, etc. The outputs from the pixel cells can be used to perform depth sensing operations based on, for example, detecting patterns of the reflected structured light, measuring a time-of-flight of the light pulse, etc. To detect patterns of the reflected structured light, a distribution of quantities of charge generated by the pixel cells during the exposure time can be determined, and pixel values can be generated based on the voltages corresponding to the quantities of charge. For time-of-flight measurement, the timing of generation of the charge at the photodiodes of the pixel cells can be determined to represent the times when the reflected light pulses are received at the pixel cells. Time differences between when the light pulses are projected to the object and when the reflected light pulses are received at the pixel cells can be used to provide the time-of-flight measurement.

A pixel cell array can be used to generate information of a scene. In some examples, a subset (e.g., a first set) of the pixel cells within the array can detect visible components of light to perform 2D sensing of the scene, and another subset (e.g., a second set) of the pixel cells within the array can detect an infrared component of the light to perform 3D sensing of the scene. The fusion of 2D and 3D imaging data are useful for many applications that provide virtual-reality (VR), augmented-reality (AR) and/or mixed reality (MR) experiences. For example, a wearable VR/AR/MR system may perform a scene reconstruction of an environment in which the user of the system is located. Based on the reconstructed scene, the VR/AR/MR can generate display effects to provide an interactive experience. To reconstruct a scene, a subset of pixel cells within a pixel cell array can perform 3D sensing to, for example, identify a set of physical objects in the environment and determine the distances between the physical objects and the user. Another subset of pixel cells within the pixel cell array can perform 2D sensing to, for example, capture visual attributes including textures, colors, and reflectivity of these physical objects. The 2D and 3D image data of the scene can then be merged to create, for example, a 3D model of the scene including the visual attributes of the objects. As another example, a wearable VR/AR/MR system can also perform a head tracking operation based on a fusion of 2D and 3D image data. For example, based on the 2D image data, the VR/AR/AR system can extract certain image features to identify an object. Based on the 3D image data, the VR/AR/AR system can track a location of the identified object relative to the wearable device worn by the user. The VR/AR/AR system can track the head movement based on, for example, tracking the change in the location of the identified object relative to the wearable device as the user's head moves.

To improve the correlation of 2D and 3D image data, an array of pixel cells can be configured to provide collocated imaging of different components of incident light from a spot of a scene. Specifically, each pixel cell can include a plurality of photodiodes, and a plurality of corresponding charge sensing units. Each photodiode of the plurality of photodiodes is configured to convert a different light component of incident light to charge. To enable the photodiodes to receive different light components of the incident light, the photodiodes can be formed in a stack which provides different absorption distances for the incident light for different photodiodes, or can be formed on a plane under an array of optical filters. Each charge sensing unit includes one or more capacitors to sense the charge of the corresponding photodiode by converting the charge to a voltage, which can be quantized by an ADC to generate a digital representation of an intensity of an incident light component converted by each photodiode. The ADC includes a comparator. As part of a quantization operation, the comparator can compare the voltage with a reference to output a decision. The output of the comparator can control when a memory stores a value from a free-running counter. The value can provide a result of quantizing the voltage.

There are various performance metrics of an image sensor, such as dynamic range, power, frame rate, etc. The dynamic range can refer to a range of light intensity measurable by the image sensor. For dynamic range, the upper limit can be defined based on the linearity of the light intensity measurement operation provided by the image sensor, whereas the lower limit can be defined based on the noise signals (e.g., dark charge, thermal noise, etc.) that affect the light intensity measurement operation. On the other hand, various factors can affect the frame rate, which can refer to the amount of time it takes for the image sensor to generate an image frame. The factors may include, for example, the time of completion of the quantization operation, various delays introduced to the quantization operation, etc.

To increase the dynamic range of the light intensity measurement operation, the ADC can quantize the voltages based on different quantization operations associated with different intensity ranges. Specifically, each photodiode can generate a quantity of charge within an exposure period, with the quantity of charge representing the incident light intensity. Each photodiode also has a quantum well to store at least some of the charge as residual charge. The quantum well capacity can be set based on a bias voltage on the switch between the photodiode and the charge sensing unit. For a low light intensity range, the photodiode can store the entirety of the charge as residual charge in the quantum well. In a PD ADC quantization operation, the ADC can quantize a first voltage generated by the charge sensing unit from sensing a quantity of the residual charge to provide a digital representation of the low light intensity. As the residual charge is typically much less susceptible to dark current in the photodiode, the noise floor of the low light intensity measurement can be lowered, which can further extend the lower limit of the dynamic range.

Moreover, for a medium light intensity range, the quantum well can be saturated by the residual charge, and the photodiode can transfer the remaining charge as overflow charge to the charge sensing unit, which can generate a second voltage from sensing a quantity of the overflow charge. In a FD ADC quantization operation, the ADC can quantize the second voltage to provide a digital representation of the medium light intensity. For both low and medium light intensities, the one or more capacitors in the charge sensing unit are not yet saturated, and the magnitudes of the first voltage and second voltage correlate with the light intensity. Accordingly for both low and medium light intensities, the comparator of the ADC can compare the first voltage or second voltage against a ramping voltage to generate a decision. The decision can control the memory to store a counter value which can represent a quantity of residual charge or overflow charge.

For a high light intensity range, the overflow charge can saturate the one or more capacitors in the charge sensing unit. As a result, the magnitudes of the second voltage no longer tracks the light intensity, and non-linearity can be introduced to the light intensity measurement. To reduce the non-linearity caused by the saturation of the capacitors, the ADC can perform a time-to-saturation (TTS) measurement operation by comparing the second voltage with a static threshold to generate a decision, which can control the memory to store a counter value. The counter value can represent a time when the second voltage reaches a saturation threshold. The time-to-saturation can represent the intensity of light in a range where the charge sensing unit is saturated and the value second voltage no longer reflects the intensity of light. With such arrangements, the upper limit of the dynamic range can be extended.

On the other hand, the operational speed of the image sensor can be improved based on various techniques, such as reducing the total time of completion of the quantization operations for all the photodiodes of a pixel cell, especially in a case where multiple quantization operations are performed on the charge generated by a photodiode to improve dynamic range, as described above. One way to reduce the total time of completion of the quantization operations is to enable parallel quantization operations for each photodiode by, for example, providing a comparator for each photodiode in a pixel cell, such that each photodiode of the pixel cell has its own dedicated comparator to perform the multiple quantization operations.

While including multiple comparators in each pixel cell of an image sensor can reduce the total time of completion of the quantization operations for each pixel cell and improve the operational speed of the image sensor, such arrangements can substantially increase the power consumption and the size of the pixel cell, both are which are undesirable especially for a wearable application. Specifically, the comparator typically comprises analog circuits (e.g., differential pairs, biasing circuits, output stages, etc.) which consume lots of static current. Moreover, those analog circuits typically use transistor devices that are of a different process node from the digital circuits and the photodiode devices of the pixel cell, and occupy far more spaces than the digital circuits and the photodiode devices. As the advancement in the process technologies further shrinks the sizes of the photodiodes and allows more photodiodes to be included in an image sensor to improve resolution, the power and space required by the comparators can become a bottleneck that limits how many photodiodes can be included in the image sensor, especially in a case where each photodiode is to have a dedicated comparator.

Besides parallelizing the quantization operations for each photodiode in a pixel cell, another way to improve the operational speed of the image sensor is by reducing the various delays introduced to the quantization operation. One source of delay can be the time for moving the quantization results (e.g., pixel data) out of the image sensor to a host device of the application that consumes the quantization results. For example, a subsequent quantization operation may be put on hold to wait for the quantization results of a previous quantization operation to be transferred to the host device. The operation speed of the image sensor can be improved if the hold time of the subsequent quantization operation can be reduced or minimized.

An image sensor described in this application can provide improved collocated 2D and 3D imaging operations, as well as improved global shutter operations, by addressing at least some of the issues above. Specifically, an image sensor may include a first photodiode, a second photodiode, a quantizer, a first memory bank, a second memory bank, and a controller. The first photodiode can generate a first charge in response to incident light, whereas the second photodiode can generate a second charge in response to the incident light. The quantizer includes a comparator and is shared between the first photodiode and the second photodiode. The controller can control the quantizer to perform a first quantization operation and a second quantization operation of the first charge to generate, respectively, a first digital output and a second digital output, the first quantization and the second quantization operations being associated with different intensity ranges, and store one of the first digital output or the second digital output in the first memory bank. Moreover, the controller can control the quantizer to perform a third quantization operation of the second charge to generate a third digital output, and 5 store the third digital output in the second memory bank. The third quantization operation is associated with different intensity ranges from at least one of the first or second quantization operations.

In one example, the image sensor may include a charge sensing unit shared between the first photodiode and the second photodiode, and the quantizer can quantize the output of the charge sensing unit. The charge sensing unit may include a capacitor to convert the first charge and the second charge to, respectively, a first voltage and a second voltage, which can be quantized by the quantizer. Specifically, within an exposure time, the controller can first connect the charge sensing unit to the first photodiode to receive a first overflow charge from the first photodiode as part of the first charge, while the first photodiode and the second photodiode 15 accumulate, respectively, the first residual charge (as part of the first charge) and the second residual charge (as part of the second charge). During the exposure period, the first overflow charge stored at the capacitor may develop the first voltage, and the quantizer can perform at least one of the TTS or the FD ADC operation on the first voltage to generate the first digital output.

After the exposure period ends, a PD ADC operation can be performed for the first photodiode, in which the first residual charge accumulated at the first photodiode is transferred to the charge sensing unit to obtain a new first voltage. The new first voltage can be quantized by the quantizer to generate the second digital output. Based on whether the capacitor of the charge sensing unit is saturated by the first overflow charge, and whether the first photodiode is saturated by the first residual charge, one of the first digital output (from either the TTS or the FD ADC operation) or the second digital output (from the PD ADC operation) can be stored in the first memory bank. After the PD ADC operation for the first photodiode completes, the controller can control the second photodiode to transfer the second residual charge to the charge sensing unit to generate the second voltage, and control the quantizer to perform a PD ADC operation on the second voltage to generate the third digital output. The third digital output can be stored in the second memory bank.

The first photodiode and the second photodiode can be part of the same pixel cell or of different pixel cells of the image sensor. The first photodiode and the second photodiode can be configured to detect different components of the incident light. In one example, the first photodiode can be configured to detect visible components of the incident light to generate pixel data for 2D imaging, whereas the second photodiode can be configured to detect infrared components of the incident light to generate pixel data for 3D imaging. The first memory bank can be part of a first memory for storing a 2D image frame, whereas the second memory bank can be part of a second memory for storing a 3D image frame.

The arrangements above can improve the performance and reduce the size and power of an image sensor. Specifically, by providing additional memory banks to store a 2D image frame and a 3D image frame generated from the completed quantization operations, the 2D and 3D image frames can be read out from the memory and transferred to the host device while the subsequent quantization operations for the next frame is underway. Compared with a case where a single memory bank is shared by multiple photodiodes, and the quantization of the output of one photodiode needs to be put on hold until the quantization result stored in the memory bank is read out and can be erased, the arrangements above can reduce the delay introduced to the quantization operations and can improve the operational speed of the image sensor. Moreover, by sharing the comparator between the photodiodes, the power and the size of the image sensor, which is typically dominated by the analog circuits of the comparator, can be reduced. On the other hand, given that the memory banks are typically implemented as digital circuits which occupy much less space and consume much less power than the comparator, including additional memory banks typically do not lead to substantial increase in size and power consumption of the image sensor, especially when the memory banks are fabricated with advanced process technologies.

The image sensor may include additional charge sensing units and additional memory banks, and the mapping between the photodiodes and the memory banks can vary based on different applications. In one example, the image sensor may include two pixel cells, each pixel cell including a pair of photodiodes and a charge sensing unit. The two charge sensing units (of the two pixel cells) can share the comparator. The first photodiode can be of the first pixel cell, whereas the second photodiode can be of the second pixel cell. The comparator can be first connected to the charge sensing unit of the first pixel cell to perform the TTS, FD ADC, and PD ADC operations for the first photodiode, and store the output of one of the operations at the first memory bank. The comparator can then be connected to the charge sensing unit of the second pixel cell to perform the FD ADC and PD ADC operations for the second photodiode, and store the output of one of the operations at the second memory bank. For the other photodiodes in the pixel cells, only PD ADC operations are performed, and the results of the PD ADC operations can be stored in the first and second memory banks after the outputs of the first and second photodiodes have been read out.

As another example, each pixel cell of the image sensor may include four photodiodes sharing a charge sensing unit, and the image sensor may include four memory banks. In some examples, the memory banks can be evenly distributed among the pixel cells, such as having two memory banks to store the outputs of the first pixel cell and the other two memory banks to store the outputs of the second pixel cell. In some examples, the memory banks can be preferentially assigned to store the outputs of a pixel cell based on, for example, the pixel cell being part of a region of interest and the outputs of the pixel cell need to be read out prior to other pixel cells to, for example, dynamically change the quantization operations of the other pixel cells, such as to set the exposure time of the other pixel cells, to enable/disable certain quantization operations of the other pixel cells, etc. As another example, multiple memory banks can be assigned to store the outputs of a photodiode. Such arrangements can be used to enable multiple sampling of the voltage at the charge sensing unit resulted from the accumulation of residual charge/overflow charge, which can improve the resolution of the quantization. In such an example, each of the memory banks can store a digital sample of the voltage, and the digital samples can be read averaged (or otherwise post-processed) to generate the digital output representing the residual charge/overflow charge.

Such image sensors may include, or be implemented in conjunction with, an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some examples, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

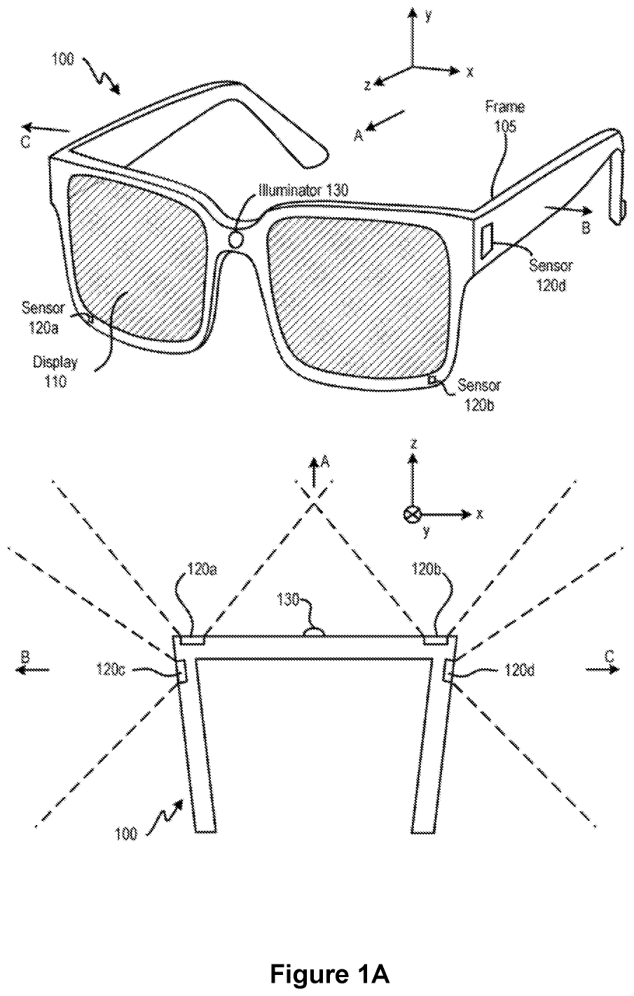

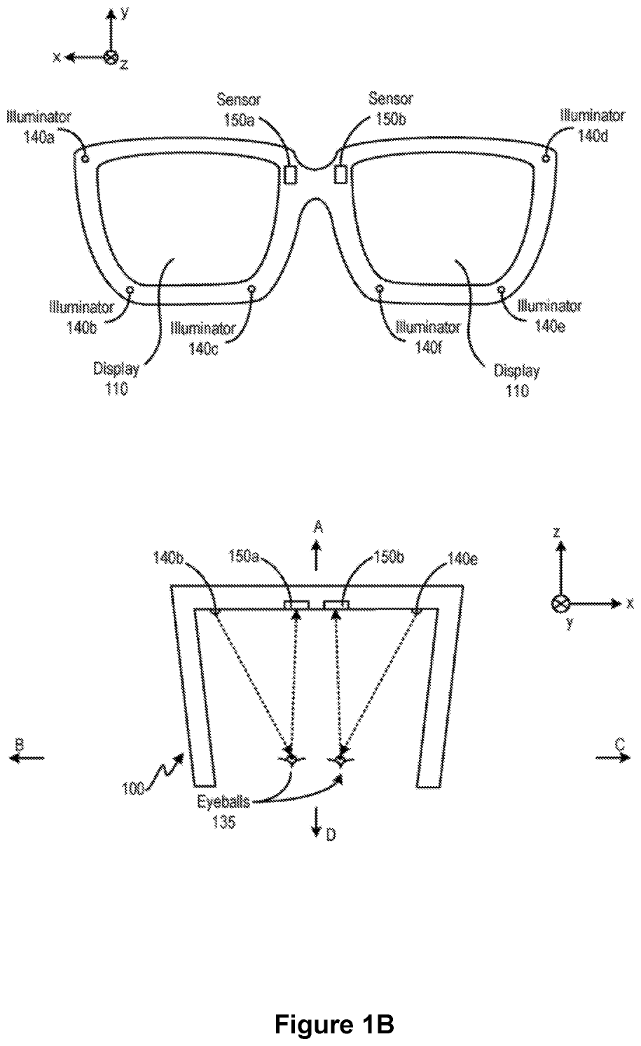

FIG. 1A is a diagram of an example of a near-eye display 100. Near-eye display 100 presents media to a user. Examples of media presented by near-eye display 100 include one or more images, video, and/or audio. In some examples, audio is presented via an external device (e.g., speakers and/or headphones) that receives audio information from the near-eye display 100, a console, or both, and presents audio data based on the audio information. Near-eye display 100 is generally configured to operate as a virtual reality (VR) display. In some examples, near-eye display 100 is modified to operate as an augmented reality (AR) display and/or a mixed reality (MR) display.

Near-eye display 100 includes a frame 105 and a display 110. Frame 105 is coupled to one or more optical elements. Display 110 is configured for the user to see content presented by near-eye display 100. In some examples, display 110 comprises a waveguide display assembly for directing light from one or more images to an eye of the user.

Near-eye display 100 further includes image sensors 120a, 120b, 120c, and 120d. Each of image sensors 120a, 120b, 120c, and 120d may include a pixel array configured to generate image data representing different fields of views along different directions. For example, sensors 120a and 120b may be configured to provide image data representing two fields of view towards a direction A along the Z axis, whereas sensor 120c may be configured to provide image data representing a field of view towards a direction B along the X axis, and sensor 120d may be configured to provide image data representing a field of view towards a direction C along the X axis.

In some examples, sensors 120a-120d can be configured as input devices to control or influence the display content of the near-eye display 100, to provide an interactive VR/AR/MR experience to a user who wears near-eye display 100. For example, sensors 120a-120d can generate physical image data of a physical environment in which the user is located. The physical image data can be provided to a location tracking system to track a location and/or a path of movement of the user in the physical environment. A system can then update the image data provided to display 110 based on, for example, the location and orientation of the user, to provide the interactive experience. In some examples, the location tracking system may operate a SLAM algorithm to track a set of objects in the physical environment and within a view of field of the user as the user moves within the physical environment. The location tracking system can construct and update a map of the physical environment based on the set of objects, and track the location of the user within the map. By providing image data corresponding to multiple fields of views, sensors 120a-120d can provide the location tracking system a more holistic view of the physical environment, which can lead to more objects to be included in the construction and updating of the map. With such an arrangement, the accuracy and robustness of tracking a location of the user within the physical environment can be improved.

In some examples, near-eye display 100 may further include one or more active illuminators 130 to project light into the physical environment. The light projected can be associated with different frequency spectrums (e.g., visible light, infrared light, ultra-violet light, etc.), and can serve various purposes. For example, illuminator 130 may project light in a dark environment (or in an environment with low intensity of infrared light, ultra-violet light, etc.) to assist sensors 120a-120d in capturing images of different objects within the dark environment to, for example, enable location tracking of the user. Illuminator 130 may project certain markers onto the objects within the environment, to assist the location tracking system in identifying the objects for map construction/updating.

In some examples, illuminator 130 may also enable stereoscopic imaging. For example, one or more of sensors 120a or 120b can include both a first pixel array for visible light sensing and a second pixel array for infrared (IR) light sensing. The first pixel array can be overlaid with a color filter (e.g., a Bayer filter), with each pixel of the first pixel array being configured to measure intensity of light associated with a particular color (e.g., one of red, green or blue colors). The second pixel array (for IR light sensing) can also be overlaid with a filter that allows only IR light through, with each pixel of the second pixel array being configured to measure intensity of IR lights. The pixel arrays can generate an RGB image and an IR image of an object, with each pixel of the IR image being mapped to each pixel of the RGB image. Illuminator 130 may project a set of IR markers on the object, the images of which can be captured by the IR pixel array. Based on a distribution of the IR markers of the object as shown in the image, the system can estimate a distance of different parts of the object from the IR pixel array, and generate a stereoscopic image of the object based on the distances. Based on the stereoscopic image of the object, the system can determine, for example, a relative position of the object with respect to the user, and can update the image data provided to display 100 based on the relative position information to provide the interactive experience.

As discussed above, near-eye display 100 may be operated in environments associated with a very wide range of light intensities. For example, near-eye display 100 may be operated in an indoor environment or in an outdoor environment, and/or at different times of the day. Near-eye display 100 may also operate with or without active illuminator 130 being turned on. As a result, image sensors 120a-120d may need to have a wide dynamic range to be able to operate properly (e.g., to generate an output that correlates with the intensity of incident light) across a very wide range of light intensities associated with different operating environments for near-eye display 100.

FIG. 1B is a diagram of another example of near-eye display 100. FIG. 1B illustrates a side of near-eye display 100 that faces the eyeball(s) 135 of the user who wears near-eye display 100. As shown in FIG. 1B, near-eye display 100 may further include a plurality of illuminators 140a, 140b, 140c, 140d, 140e, and 140f. Near-eye display 100 further includes a plurality of image sensors 150a and 150b. Illuminators 140a, 140b, and 140c may emit lights of certain frequency range (e.g., NIR) towards direction D (which is opposite to direction A of FIG. 1A). The emitted light may be associated with a certain pattern, and can be reflected by the left eyeball of the user. Sensor 150a may include a pixel array to receive the reflected light and generate an image of the reflected pattern. Similarly, illuminators 140d, 140e, and 140f may emit NIR lights carrying the pattern. The NIR lights can be reflected by the right eyeball of the user, and may be received by sensor 150b. Sensor 150b may also include a pixel array to generate an image of the reflected pattern. Based on the images of the reflected pattern from sensors 150a and 150b, the system can determine a gaze point of the user, and update the image data provided to display 100 based on the determined gaze point to provide an interactive experience to the user.

As discussed above, to avoid damaging the eyeballs of the user, illuminators 140a, 140b, 140c, 140d, 140e, and 140f are typically configured to output lights of very low intensities. In a case where image sensors 150a and 150b comprise the same sensor devices as image sensors 10120a-120d of FIG. 1A, the image sensors 120a-120d may need to be able to generate an output that correlates with the intensity of incident light when the intensity of the incident light is very low, which may further increase the dynamic range requirement of the image sensors.

Moreover, the image sensors 120a-120d may need to be able to generate an output at a high speed to track the movements of the eyeballs. For example, a user's eyeball can perform a very rapid movement (e.g., a saccade movement) in which there can be a quick jump from one eyeball position to another. To track the rapid movement of the user's eyeball, image sensors 120a-120d need to generate images of the eyeball at high speed. For example, the rate at which the image sensors generate an image frame (the frame rate) needs to at least match the speed of movement of the eyeball. The high frame rate requires short total exposure time for all of the pixel cells involved in generating the image frame, as well as high speed for converting the sensor outputs into digital values for image generation. Moreover, as discussed above, the image sensors also need to be able to operate at an environment with low light intensity.

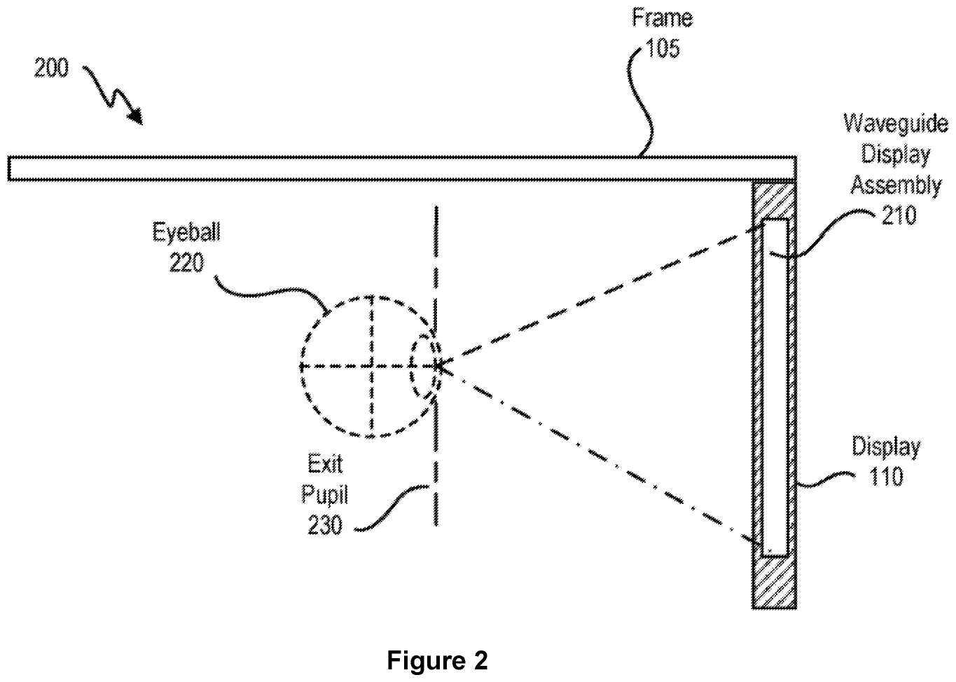

FIG. 2 is an example of a cross section 200 of near-eye display 100 illustrated in FIGS. 1A and 1B. Display 110 includes at least one waveguide display assembly 210. An exit pupil 230 is a location where a single eyeball 220 of the user is positioned in an eyebox region when the user wears the near-eye display 100. For purposes of illustration, FIG. 2 shows the cross section 200 associated eyeball 220 and a single waveguide display assembly 210, but a second waveguide display is used for a second eye of a user.

Waveguide display assembly 210 is configured to direct image light to an eyebox located at exit pupil 230 and to eyeball 220. Waveguide display assembly 210 may be composed of one or more materials (e.g., plastic, glass, etc.) with one or more refractive indices. In some examples, near-eye display 100 includes one or more optical elements between waveguide display assembly 210 and eyeball 220.

In some examples, waveguide display assembly 210 includes a stack of one or more waveguide displays including, but not restricted to, a stacked waveguide display, a varifocal waveguide display, etc. The stacked waveguide display is a polychromatic display (e.g., a red-green-blue (RGB) display) created by stacking waveguide displays whose respective monochromatic sources are of different colors. The stacked waveguide display is also a polychromatic display that can be projected on multiple planes (e.g., multi-planar colored display). In some configurations, the stacked waveguide display is a monochromatic display that can be projected on multiple planes (e.g., multi-planar monochromatic display). The varifocal waveguide display is a display that can adjust a focal position of image light emitted from the waveguide display. In alternate examples, waveguide display assembly 210 may include the stacked waveguide display and the varifocal waveguide display.

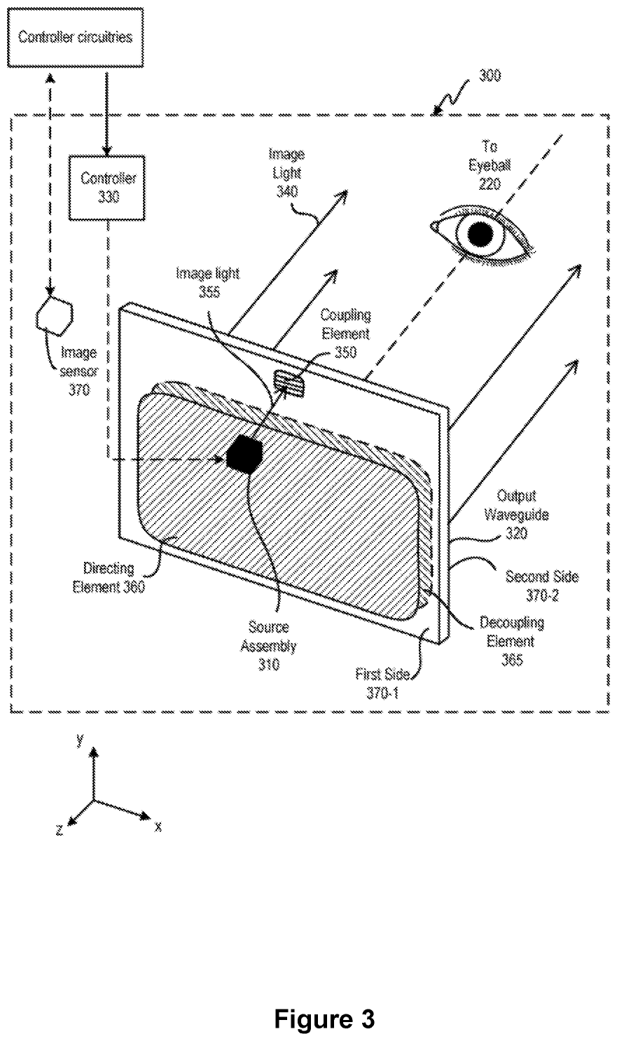

FIG. 3 illustrates an isometric view of an example of a waveguide display 300. In some examples, waveguide display 300 is a component (e.g., waveguide display assembly 210) of near-eye display 100. In some examples, waveguide display 300 is part of some other near-eye display or other system that directs image light to a particular location.

Waveguide display 300 includes a source assembly 310, an output waveguide 320, and a controller 330. For purposes of illustration, FIG. 3 shows the waveguide display 300 associated with a single eyeball 220, but in some examples, another waveguide display separate, or partially separate, from the waveguide display 300 provides image light to another eye of the user.

Source assembly 310 generates image light 355. Source assembly 310 generates and outputs image light 355 to a coupling element 350 located on a first side 370-1 of output waveguide 320. Output waveguide 320 is an optical waveguide that outputs expanded image light 340 to an eyeball 220 of a user. Output waveguide 320 receives image light 355 at one or more coupling elements 350 located on the first side 370-1 and guides received input image light 355 to a directing element 360. In some examples, coupling element 350 couples the image light 355 from source assembly 310 into output waveguide 320. Coupling element 350 may be, e.g., a diffraction grating, a holographic grating, one or more cascaded reflectors, one or more prismatic surface elements, and/or an array of holographic reflectors.

Directing element 360 redirects the received input image light 355 to decoupling element 365 such that the received input image light 355 is decoupled out of output waveguide 5320 via decoupling element 365. Directing element 360 is part of, or affixed to, first side 370-1 of output waveguide 320. Decoupling element 365 is part of, or affixed to, second side 370-2 of output waveguide 320, such that directing element 360 is opposed to the decoupling element 365. Directing element 360 and/or decoupling element 365 may be, e.g., a diffraction grating, a holographic grating, one or more cascaded reflectors, one or more prismatic surface elements, and/or an array of holographic reflectors.

Second side 370-2 represents a plane along an x-dimension and a y-dimension. Output waveguide 320 may be composed of one or more materials that facilitate total internal reflection of image light 355. Output waveguide 320 may be composed of e.g., silicon, plastic, glass, and/or polymers. Output waveguide 320 has a relatively small form factor. For example, output waveguide 320 may be approximately 50 mm wide along x-dimension, 30 mm long along y-dimension and 0.5-1 mm thick along a z-dimension.

Controller 330 controls scanning operations of source assembly 310. The controller 330 determines scanning instructions for the source assembly 310. In some examples, the output waveguide 320 outputs expanded image light 340 to the user's eyeball 220 with a large field of view (FOV). For example, the expanded image light 340 is provided to the user's eyeball 220 with a diagonal FOV (in x and y) of 60 degrees and/or greater and/or 150 degrees and/or less. The output waveguide 320 is configured to provide an eyebox with a length of 20 mm or greater and/or equal to or less than 50 mm; and/or a width of 10 mm or greater and/or equal to or less than 50 mm.

Moreover, controller 330 also controls image light 355 generated by source assembly 310, based on image data provided by image sensor 370. Image sensor 370 may be located on first side 370-1 and may include, for example, image sensors 120a-120d of FIG. 1A to generate image data of a physical environment in front of the user (e.g., for location determination). Image sensor 370 may also be located on second side 370-2 and may include image sensors 150a and 150b of FIG. 1B to generate image data of eyeball 220 (e.g., for gaze point determination) of the user. Image sensor 370 may interface with a remote console that is not located within waveguide display 300. Image sensor 370 may provide image data to the remote console, which may determine, for example, a location of the user, a gaze point of the user, etc., and determine the content of the images to be displayed to the user. The remote console can transmit instructions to controller 330 related to the determined content. Based on the instructions, controller 330 can control the generation and outputting of image light 355 by source assembly 310.

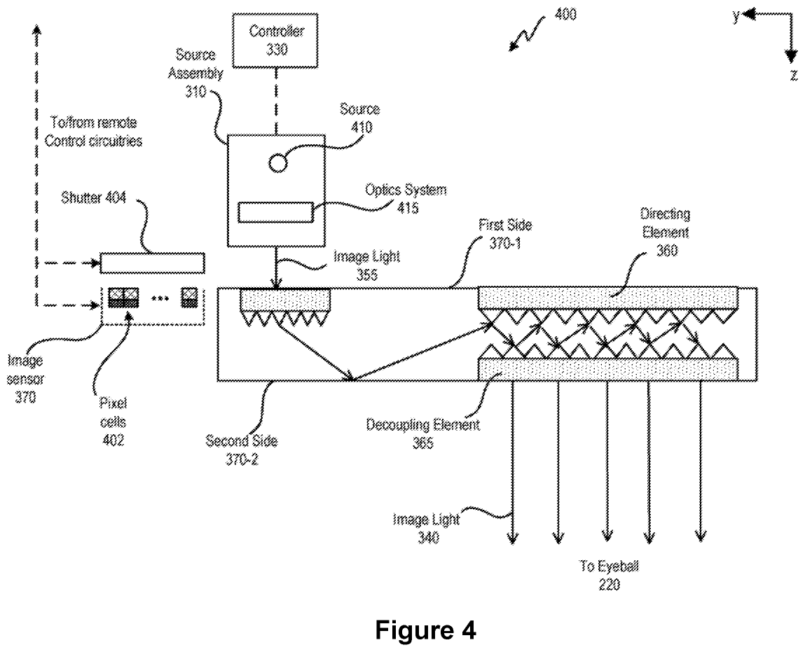

FIG. 4 illustrates an example of a cross section 400 of the waveguide display 300. The cross section 400 includes source assembly 310, output waveguide 320, and image sensor 370. In the example of FIG. 4, image sensor 370 may include a set of pixel cells 402 located on first side 370-1 to generate an image of the physical environment in front of the user. In some examples, there can be a mechanical shutter 404 interposed between the set of pixel cells 402 and the physical environment to control the exposure of the set of pixel cells 402. In some examples, the mechanical shutter 404 can be replaced by an electronic shutter gate, as to be discussed below. Each of pixel cells 402 may correspond to one pixel of the image. Although not shown in FIG. 4, it is understood that each of pixel cells 402 may also be overlaid with a filter to control the frequency range of the light to be sensed by the pixel cells.

After receiving instructions from the remote console, mechanical shutter 404 can open and expose the set of pixel cells 402 in an exposure period. During the exposure period, image sensor 370 can obtain samples of lights incident on the set of pixel cells 402, and generate image data based on an intensity distribution of the incident light samples detected by the set of pixel cells 402. Image sensor 370 can then provide the image data to the remote console, which determines the display content, and provide the display content information to controller 330. Controller 330 can then determine image light 355 based on the display content information.

Source assembly 310 generates image light 355 in accordance with instructions from the controller 330. Source assembly 310 includes a source 410 and an optics system 415. Source 410 is a light source that generates coherent or partially coherent light. Source 410 may be, e.g., a laser diode, a vertical cavity surface emitting laser, and/or a light emitting diode.

Optics system 415 includes one or more optical components that condition the light from source 410. Conditioning light from source 410 may include, e.g., expanding, collimating, and/or adjusting orientation in accordance with instructions from controller 330. The one or more optical components may include one or more lenses, liquid lenses, mirrors, apertures, and/or gratings. In some examples, optics system 415 includes a liquid lens with a plurality of electrodes that allows scanning of a beam of light with a threshold value of scanning angle to shift the beam of light to a region outside the liquid lens. Light emitted from the optics system 415 (and also source assembly 310) is referred to as image light 355.

Output waveguide 320 receives image light 355. Coupling element 350 couples image light 355 from source assembly 310 into output waveguide 320. In examples where coupling element 350 is diffraction grating, a pitch of the diffraction grating is chosen such that total internal reflection occurs in output waveguide 320, and image light 355 propagates internally in output waveguide 320 (e.g., by total internal reflection), toward decoupling element 365.

Directing element 360 redirects image light 355 toward decoupling element 365 for decoupling from output waveguide 320. In examples where directing element 360 is a diffraction grating, the pitch of the diffraction grating is chosen to cause incident image light 355 to exit output waveguide 320 at angle(s) of inclination relative to a surface of decoupling element 365.

In some examples, directing element 360 and/or decoupling element 365 are structurally similar. Expanded image light 340 exiting output waveguide 320 is expanded along one or more dimensions (e.g., may be elongated along x-dimension). In some examples, waveguide display 300 includes a plurality of source assemblies 310 and a plurality of output waveguides 320. Each of source assemblies 310 emits a monochromatic image light of a specific band of wavelength corresponding to a primary color (e.g., red, green, or blue). Each of output waveguides 320 may be stacked together with a distance of separation to output an expanded image light 340 that is multi-colored.

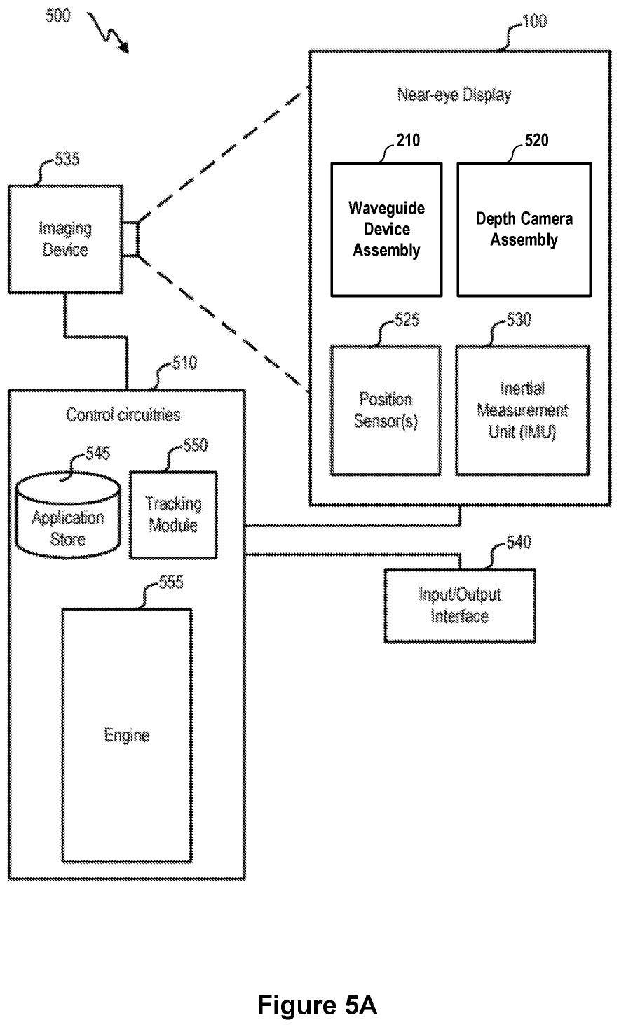

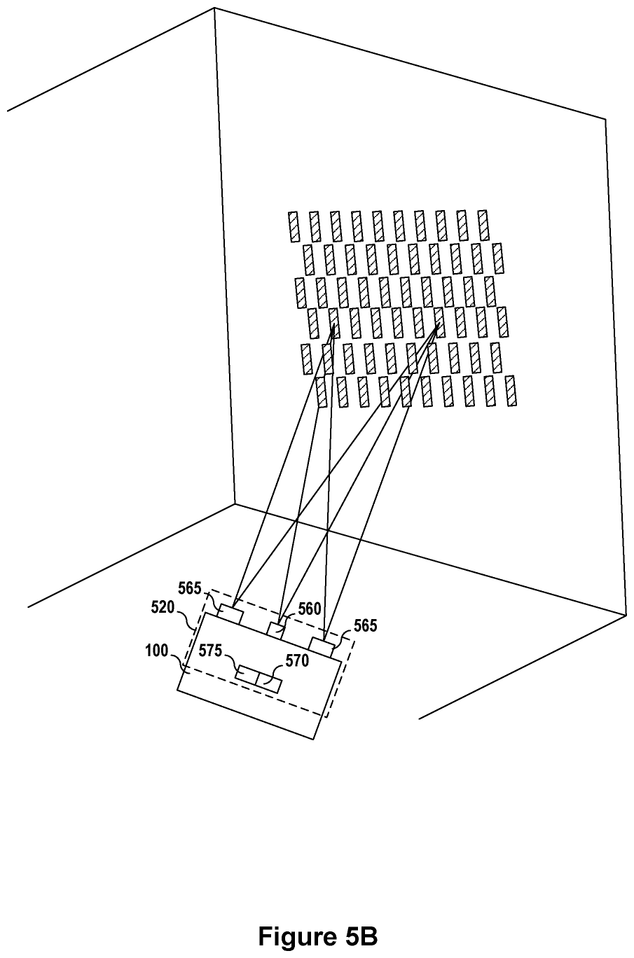

FIG. 5A is a block diagram of an example of a system 500 including the near-eye display 100. The system 500 comprises near-eye display 100, an imaging device 535, an input/output interface 540, and image sensors 120a-120d and 150a-150b that are each coupled to control circuits 510. System 500 can be configured as a head-mounted device, a wearable device, etc.

Near-eye display 100 is a display that presents media to a user. Examples of media presented by the near-eye display 100 include one or more images, video, and/or audio. In some examples, audio is presented via an external device (e.g., speakers and/or headphones) that receives audio information from near-eye display 100 and/or control circuits 510 and presents audio data based on the audio information to a user. In some examples, near-eye display 100 may also act as an AR eyewear glass. In some examples, near-eye display 100 augments views of a physical, real-world environment, with computer-generated elements (e.g., images, video, sound, etc.).

Near-eye display 100 includes waveguide display assembly 210, depth camera assembly (DCA) 520, one or more position sensors 525, and/or an inertial measurement unit (IMU) 530. Some embodiments of the near-eye display 100 have different components than those described with respect to FIG. 5A. Additionally, the functionality provided by various components described with respect to FIG. 5A may be differently distributed among the components of the near-eye display 100 in other embodiments.

In some embodiments, waveguide display assembly 210 includes source assembly 310, output waveguide 320, and controller 330.

The DCA 120 captures data describing depth information of an area surrounding the near-eye display 100. Some embodiments of the DCA 120 include one or more imaging devices (e.g., a camera, a video camera) and an illumination source configured to emit a structured light (SL) pattern. As further discussed below, structured light projects a specified pattern, such as a symmetric or quasi-random dot pattern, grid, or horizontal bars, onto a scene. For example, the illumination source emits a grid or a series of horizontal bars onto an environment surrounding the near-eye display 100. Based on triangulation, or perceived deformation of the pattern when projected onto surfaces, depth and surface information of objects within the scene is determined.

In some embodiments, to better capture depth information of the area surrounding the near-eye display 100, the DCA 120 also captures time of flight information describing times for light emitted from the illumination source to be reflected from objects in the area surrounding the near-eye display 100 back to the one or more imaging devices. In various implementations, the DCA 120 captures time-of-flight information simultaneously or near-simultaneously with structured light information. Based on the times for the emitted light to be captured by one or more imaging devices, the DCA 120 determines distances between the DCA 120 and objects in the area surrounding the near-eye display 100 that reflect light from the illumination source. To capture time of flight information as well as structured light information, the illumination source modulates the emitted SL pattern with a carrier signal having a specific frequency, such as 30 MHz (in various embodiments, the frequency may be selected from a range of frequencies between 5 MHz and 5 GHz).

The imaging devices capture and record particular ranges of wavelengths of light (e.g., “bands” of light). Example bands of light captured by an imaging device include: a visible band (˜380 nm to 750 nm), an infrared (IR) band (˜750 nm to 2,200 nm), an ultraviolet band (100 nm to 380 nm), another portion of the electromagnetic spectrum, or some combination thereof. In some embodiments, an imaging device captures images including light in the visible band and in the infrared band. To jointly capture light from the structured light pattern that is reflected from objects in the area surrounding the near-eye display 100 and determine times for the carrier signal from the illumination source to be reflected from objects in the area to the DCA 120, the imaging device includes a detector comprising an array of pixel groups. Each pixel group includes one or more pixels, and different pixel groups are associated with different phase shifts relative to a phase of the carrier signal. In various embodiments, different pixel groups are activated at different times relative to each other to capture different temporal phases of the pattern modulated by the carrier signal emitted by the illumination source. For example, pixel groups are activated at different times so that adjacent pixel groups capture light having approximately a 90, 180, or 270 degree phase shift relative to each other. The DCA 120 derives a phase of the carrier signal, which is equated to a depth from the DCA 120, from signal data captured by the different pixel groups. The captured data also generates an image frame of the spatial pattern, either through summation of the total pixel charges across the time domain, or after correct for the carrier phase signal.

IMU 530 is an electronic device that generates fast calibration data indicating an estimated position of near-eye display 100 relative to an initial position of near-eye display 100 based on measurement signals received from one or more of position sensors 525.

Imaging device 535 may generate image data for various applications. For example, imaging device 535 may generate image data to provide slow calibration data in accordance with calibration parameters received from control circuits 510. Imaging device 535 may include, for example, image sensors 120a-120d of FIG. 1A for generating image data of a physical environment in which the user is located, for performing location tracking of the user. Imaging device 535 may further include, for example, image sensors 150a-150b of FIG. 1B for generating image data for determining a gaze point of the user, to identify an object of interest of the user.

The input/output interface 540 is a device that allows a user to send action requests to the control circuits 510. An action request is a request to perform a particular action. For example, an action request may be to start or end an application or to perform a particular action within the application.

Control circuits 510 provide media to near-eye display 100 for presentation to the user in accordance with information received from one or more of: imaging device 535, near-eye display 100, and input/output interface 540. In some examples, control circuits 510 can be housed within system 500 configured as a head-mounted device. In some examples, control circuits 510 can be a standalone console device communicatively coupled with other components of system 500. In the example shown in FIG. 5, control circuits 510 include an application store 545, a tracking module 550, and an engine 555.

The application store 545 stores one or more applications for execution by the control circuits 510. An application is a group of instructions, that, when executed by a processor, generates content for presentation to the user. Examples of applications include: gaming applications, conferencing applications, video playback applications, or other suitable applications.

Tracking module 550 calibrates system 500 using one or more calibration parameters and may adjust one or more calibration parameters to reduce error in determination of the position of the near-eye display 100.

Tracking module 550 tracks movements of near-eye display 100 using slow calibration information from the imaging device 535. Tracking module 550 also determines positions of a reference point of near-eye display 100 using position information from the fast calibration information.

Engine 555 executes applications within system 500 and receives position information, acceleration information, velocity information, and/or predicted future positions of near-eye display 100 from tracking module 550. In some examples, information received by engine 555 may be used for producing a signal (e.g., display instructions) to waveguide display assembly 210 that determines a type of content presented to the user. For example, to provide an interactive experience, engine 555 may determine the content to be presented to the user based on a location of the user (e.g., provided by tracking module 550), or a gaze point of the user (e.g., based on image data provided by imaging device 535), a distance between an object and user (e.g., based on image data provided by imaging device 535).

FIG. 5B shows an example arrangement of one or more imaging device 565 (e.g., two imaging devices 565 for stereoscopic measurements) and an illumination source 560 of the DCA 520, where the illumination source 560 projecting a structured light pattern (also referred to as a spatial pattern) onto a local area. In FIG. 5B, the example spatial pattern comprises a grid pattern projected within a field of view of the illumination source 560. Through scattered or direct reflection, the spatial pattern is captured by the imaging devices 565. In some embodiments, the captured spatial pattern is stored in memory 570 of the DCA 520. One or more processors 575 of the DCA 520, through triangulation, determines the three-dimensional layout of the local area based on the captured image(s) of the projected structure light.

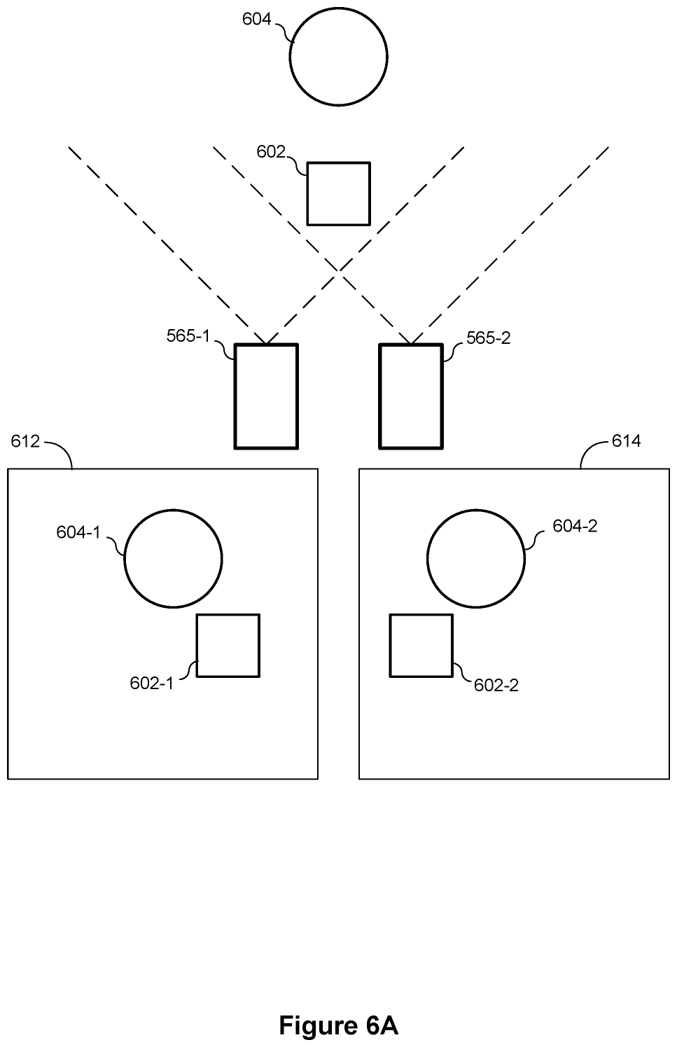

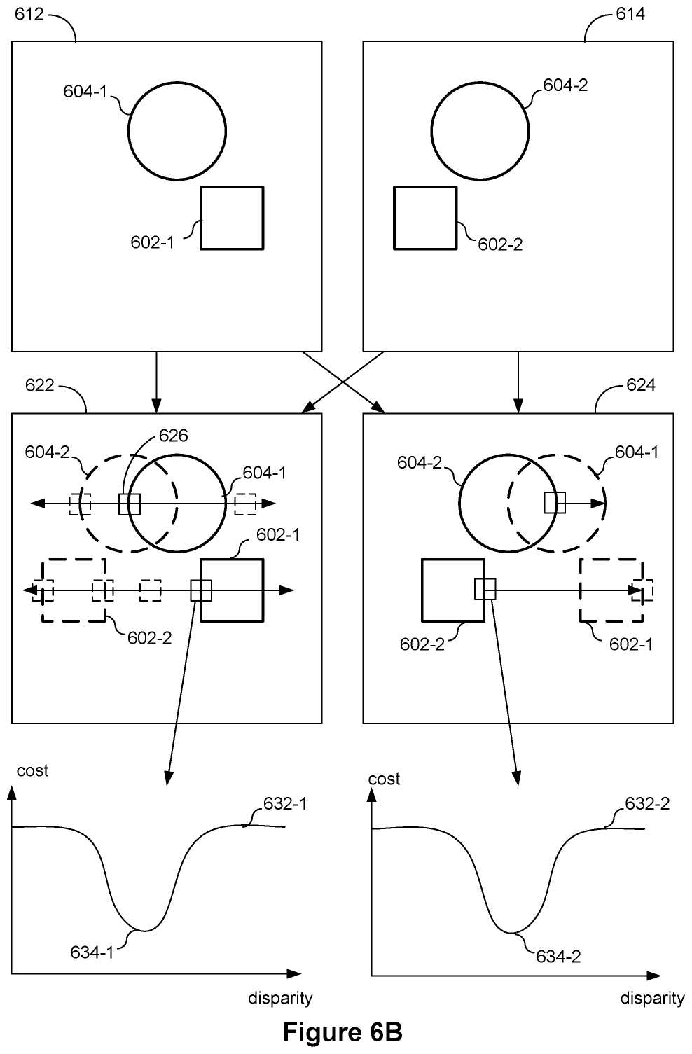

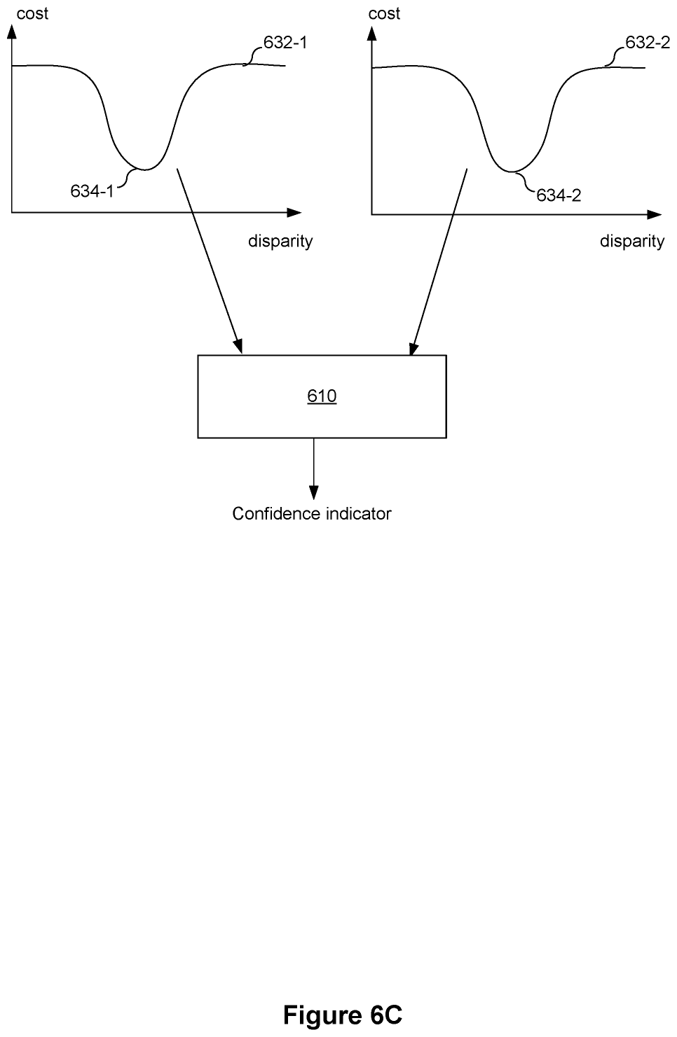

FIG. 6A is a schematic diagram illustrating images obtained by a stereoscopic imaging device (e.g., DCA 520) in accordance with some embodiments.

FIG. 6A includes a plan view (e.g., a top view) of imaging devices 565-1 and 565-2 positioned offset from each other (e.g., imaging device 565-1 is located on a left side of imaging device 565-2 and imaging device 565-2 is located on a right side of imaging device 565-1). Each of imaging device 565-1 and imaging device 565-2 takes an image of objects 602 and 604.

Image 612 is an image collected by imaging device 565-1 and image 614 is an image collected by imaging device 565-2 (in some cases, after stereo rectification to obtain common epipolar lines, which may be horizontal epipolar lines). Because imaging device 565-1 and imaging device 565-2 are offset from each other, objects 602 and 604 appear at different locations in images 612 and 614. For example, in image 612, image 604-1 of object 604 appears on an upper left side of image 602-1 of object 602, and in image 614, image 604-2 of object 604 appears on an upper right side of image 602-2 of object 602. The difference between image 612 and image 614 may be used to determine the depth of object 604 and object 602.

FIG. 6B is a schematic diagram illustrating stereo matching operations in accordance with some embodiments. In stereo matching, images 612 and 614 are compared to determine a disparity (e.g., distance, which may be measured in pixels) between images of a corresponding object in images 612 and 614. In some cases, image 612 is used as a reference image and object images within image 612 are compared to object images in image 614 to determine the disparity between the object images (or portions thereof) as shown in diagram 622. For example, the disparity from the position of the image 604-1 in image 612 to the position of the image 604-2 in image 614 is determined. Similarly, the disparity from the position of the image 602-1 in image 612 to the position of the image 602-2 in image 614 is determined. In some cases, image 614 is used as a reference image and object images within images 614 are compared to object images in image 612 to determine the disparity between the object images (or portions thereof) as shown in diagram 624. For example, the disparity from the position of the image 604-2 in image 614 to the position of the image 604-1 in image 612 is determined. Similarly, the disparity from the position of the image 602-2 in image 614 to the position of the image 602-1 in image 612 is determined. In some cases, both determinations (e.g., using image 612 as a reference image and comparing the reference image to image 614 and using image 614 as a reference image and comparing the reference image to image 612) are performed. Because the images may have noises and occlusions, using image 612 as a reference image and using image 614 as a reference image may lead to different disparity values. Thus, performing both determination operations can improve the accuracy in stereo matching.

In some embodiments, determining the disparity includes determining a stereo matching difference profile (a matching cost function). In FIG. 6B, a window 626 corresponding to a region of the reference image (e.g., image 612) is scanned along the epipolar line (e.g., a horizontal line) on a target image (e.g., image 614) and a matching cost (also called herein a stereo matching difference) is determined for each scanned position of the window 626. In some cases, the matching cost is determined using a sum of squares of differences (SSD), a sum of absolute differences (SAD), a zero-mean sum of absolute differences, a locally scaled sum of absolute differences, a maximum of differences, or a correlation function (e.g., a normalized cross correlation function). For example, the sum of squares of differences may be determined using the following equation:

SSD=Σ(f(i,j)−g(i,j))²

where f is an intensity at a horizontal coordinate i and a vertical coordinate j within a particular window in the reference image, and g is an intensity at the corresponding coordinate within a corresponding window in the target image. From the matching costs for various positions of the window, the stereo matching difference profile is obtained for a particular region of the reference image (or the target image). For example, the stereo matching difference profile 632-1 is obtained by comparing image 612 to image 614 (or by comparing a window located over image 612 around a particular pixel to a window moving over image 614 along a corresponding epipolar line), and the stereo matching difference profile 632-2 is obtained by comparing image 614 to image 612 (or by comparing a window located over image 614 around a particular pixel to a window moving over image 612 along a corresponding epipolar line). In some cases, the disparity (e.g., the distance that the window has translated) which has the minimum matching cost is selected as a representative disparity between corresponding pixels in the two images (e.g., disparity 634-1 is the representative disparity between a pixel in a window located over image 602-1 of object 602 in image 612 to a corresponding pixel in a window located over image 602-2 of object 602 in image 614, and disparity 634-2 is the representative disparity between a pixel in a window located over image 602-2 of object 602 in image 614 to a corresponding pixel in a window located over image 602-1 of object 602 in image 612).

FIG. 6C is a schematic diagram illustrating operations for a left-right consistency check in accordance with some embodiments. Confidence estimator 610 determines one or more confidence values by comparing the stereo matching difference profile 632-1 and the stereo matching difference profile 632-2 (or information derived from them). In some cases, confidence estimator 610 compares the disparity 634-1 obtained by comparing the left image 612 to the right image 614 and the disparity 634-2 obtained by comparing the right image 614 to the left image 612 to determine a confidence value. For example, when the disparity 634-1 is substantially different from the disparity 634-2, the confidence value for the disparity 634-1 (or the disparity 634-2) is low. When the disparity 634-1 is substantially similar to the disparity 634-2, the confidence value for the disparity 634-1 (or the disparity 634-2) is high.

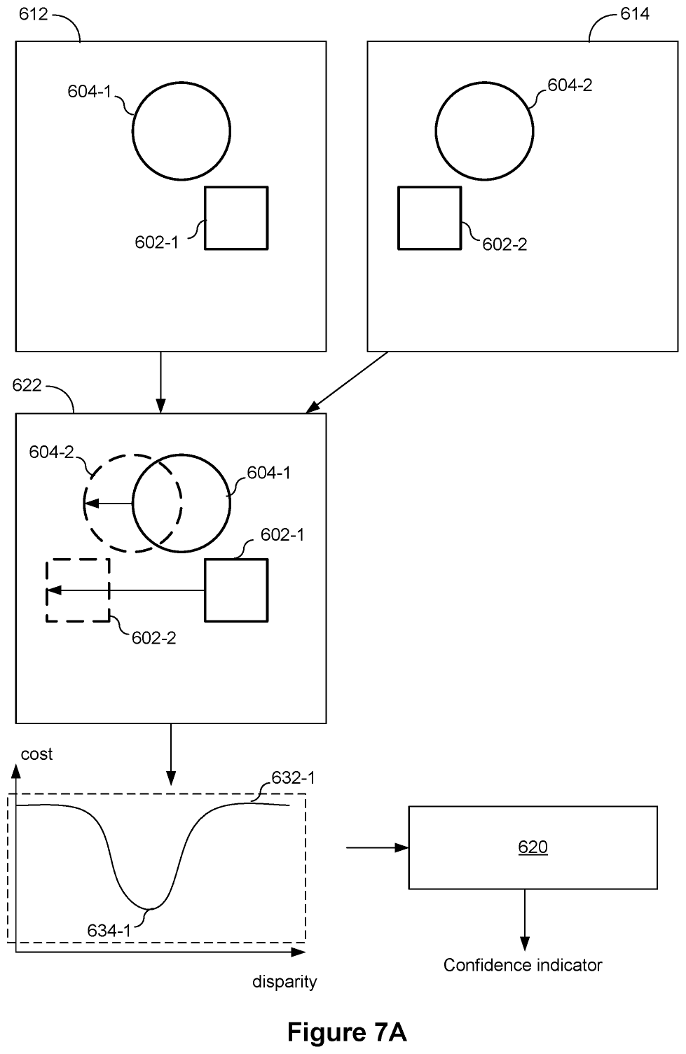

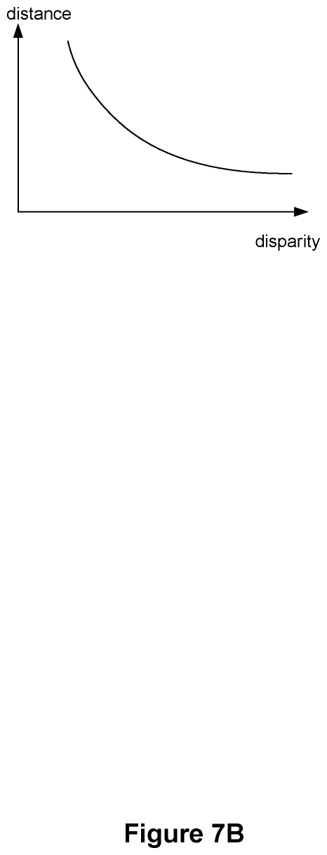

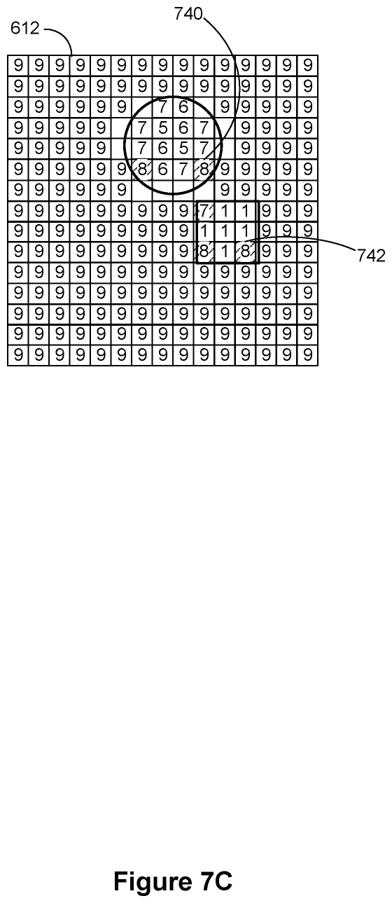

However, determining the confidence value using the left-right consistency check as shown in FIG. 6C is computationally intensive and time consuming, as it requires at least two stereo matching operations as shown in FIG. 6B. FIG. 7A is a schematic diagram illustrating operations for determining confidence in stereo matching in accordance with some embodiments. The operations illustrated in FIG. 7A allow determining a confidence value without two stereo matching operations required for the left-right consistency check, and thus are faster and more efficient than the left-right consistency check. In addition, the operations illustrated in FIG. 7A include stereo matching that can be used for the left-right consistency check. Thus, the operations illustrated in FIG. 7A can be performed in conjunction with the operations illustrated in FIGS. 6B and 6C to provide independent confidence values, which may be used to complement the confidence values obtained by the left-right consistency check.

In FIG. 7A, the stereo matching difference profile 632-1 is obtained using the operations described with respect to FIG. 6B. The confidence estimator 620 receives the stereo matching difference profile 632-1, which may be in a form of a vector, and applies a predefined classifier to the stereo matching difference profile 632-1 to obtain a confidence value. In some embodiments, the predefined classifier is based at least in part on a support vector machine. In some embodiments, the predefined classifier is based at least in part on a neural network (e.g., fully-connected neural network). In some embodiments, the predefined classifier is based at least in part on a linear classifier. The predefined classifier is trained with a training dataset before the confidence estimator 620 applies the predefined classifier to new data, such as the stereo matching difference profile 632-1. For example, when the predefined classifier is based on a support vector machine, the predefined classifier projects the input vector (e.g., the stereo matching difference profile 632-1 onto a hyperplane and determines whether the input vector is located on one side of the hyperplane or the other). In some cases, the distance from the input vector to the hyperplane is used as a confidence value. In addition, the operations illustrated in FIG. 7A can provide a higher resolution of confidence values than the operations illustrated in FIGS. 6B and 6C.

In addition to, or independently from, the confidence value, the distance to an object (e.g., a distance from imaging devices 565-1 and 565-2 or the DCA 520) may be determined from the stereo matching difference profile. FIG. 7B illustrates a prophetic example of a curve used for obtaining a distance to an object (also called depth) based on the disparity between two images in accordance with some embodiments. For example, the distance to an object may have an inversely-proportional relationship to the disparity between the images of a corresponding object in the left and right images.

In some cases, the obtained confidence values are used to filter depth information. FIG. 7C illustrates filtering depth information based on the confidence in the depth information in accordance with some embodiments. In FIG. 7C, image 612 is divided into a plurality of segments, and the depth determined from stereo matching is shown for each segment. In addition, segments 742 with low confidence values are highlighted. In some embodiments, the DCA 520, for a segment with a low confidence value, determines a substitute depth value. For example, the DCA 520 uses a depth value of an adjacent segment (or a weighted average of depth values of adjacent segments) to obtain the substitute depth value for the segment with the low confidence value.

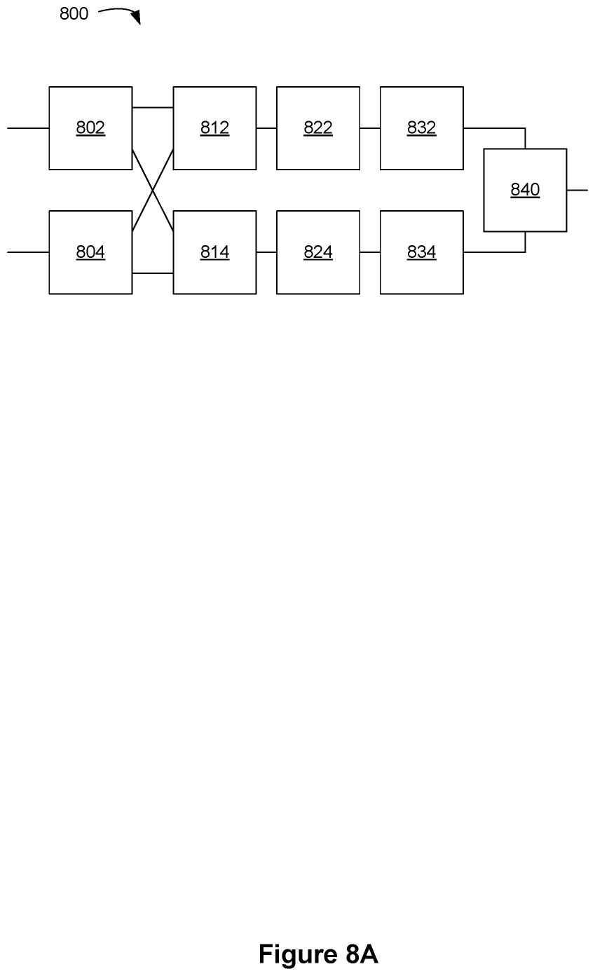

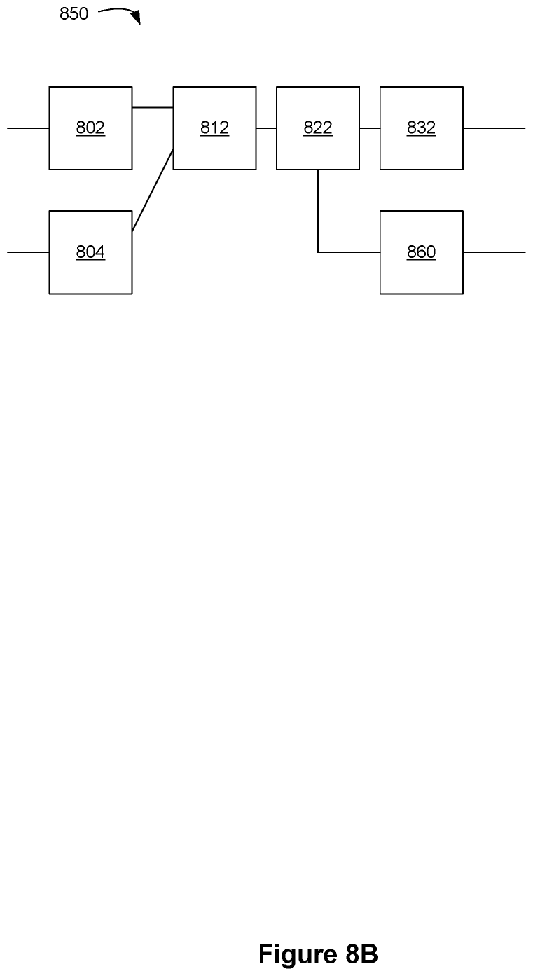

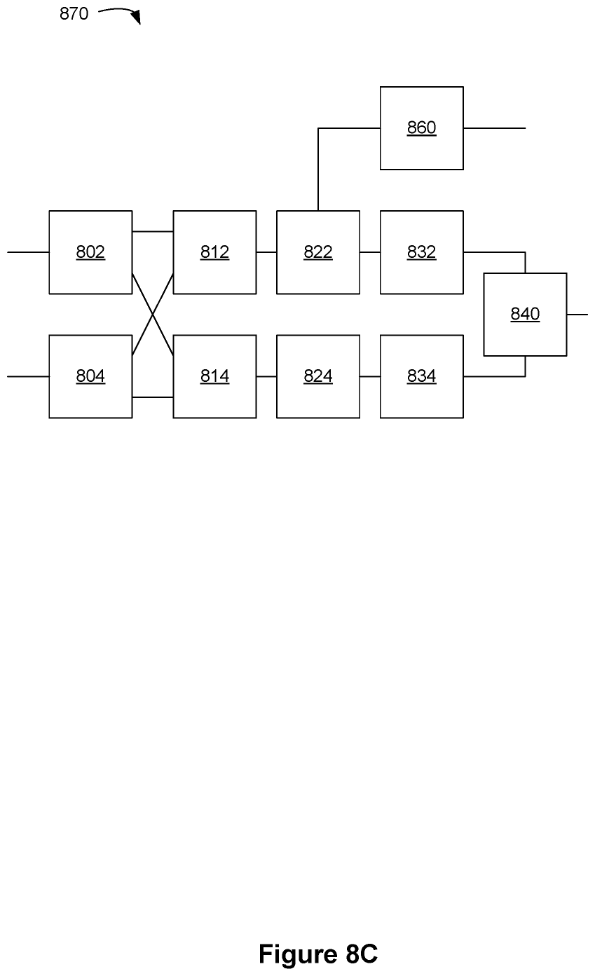

FIG. 8A illustrates components of a device 800 that determines confidence in stereo matched images based on left-right consistency check in accordance with some embodiments.

In some embodiments, the device 800 is included in the one or more processors 575 of the DCA 520. In some embodiments, the device 800 is implemented as a dedicate circuit (e.g., an application-specific integrated circuit) or a device. In some embodiments, the device 800 is implemented in a device with one or more processors and memory.

The device 800 (e.g., an image processing device) includes a receiver 802 that receives left image information. In some embodiments, the received left image information corresponds to an entire area of a left image sensor (e.g., imaging device 565-1). In some embodiments, the received left image information corresponds to a subset, less than all, of the entire area of the left image sensor (e.g., left image information corresponding to the entire area of the left image sensor may be divided into a plurality of non-overlapping blocks, which may have a same size, such as rectangles of an equal size, and the received left image information corresponds to a single block). In some embodiments, the receiver 802 includes an 8-bit to 10-bit encoder.

The device 800 also includes a receiver 804 that receives right image information. In some embodiments, the received right image information corresponds to an entire area of a right image sensor (e.g., imaging device 565-2). In some embodiments, the received right image information corresponds to a subset, less than all, of the entire area of the right image sensor (e.g., right image information corresponding to the entire area of the right image sensor may be divided into a plurality of non-overlapping blocks, which may have a same size, such as rectangles of an equal size, and the received right image information corresponds to a single block). In some embodiments, the receiver 802 includes an 8-bit to 10-bit encoder.

The device 800 includes per-pixel matching cost estimator 812, which receives the left image information and the right image information (e.g., from receivers 802 and 804), and determines a stereo matching difference profile (e.g., a stereo matching cost function) for respective pixels or regions (e.g., windows) by matching the left image information with the right image information.

The device 800 includes per-pixel matching cost estimator 814, which receives the left image information and the right image information (e.g., from receivers 802 and 804), and determines a stereo matching difference profile (e.g., a stereo matching cost function) for respective pixels or regions (e.g., windows) by matching the right image information with the left image information.

In some embodiments, the device 800 includes cost refiner 822, which adjusts the stereo matching difference profile received from the per-pixel matching cost estimator 812 (e.g., to compensate for noises in the left image information, etc.). In some embodiments, the device 800 includes cost refiner 824, which adjusts the stereo matching difference profile received from the per-pixel matching cost estimator 814 (e.g., to compensate for noises in the right image information, etc.).

The device 800 further includes cost selector 832, which selects a representative disparity (e.g., a disparity with a cost value below a threshold from, or a disparity with the minimum cost value) based on the stereo matching difference profile from cost refiner 822 (or cost estimator 812). The device 800 includes cost selector 834, which selects a representative disparity (e.g., a disparity with a cost value below a threshold from, or a disparity with the minimum cost value) based on the stereo matching difference profile from cost refiner 824 (or cost estimator 814).

The device 800 includes confidence estimator 840 (which may correspond to confidence estimator 610). The confidence estimator 840 receives the selected representative disparity values from the cost selectors 832 and 834 and determines confidence in stereo matching by comparing the selected representative disparity values received from the cost selectors 832 and 834 (or the confidence estimator 840 receives depth values corresponding to the selected representative disparity values, and determines confidence in stereo matching by comparing the received depth values).

FIG. 8B illustrates components of a device 850 that determines confidence in stereo matched images using a classifier in accordance with some embodiments.

In some embodiments, the device 850 is included in the one or more processors 575 of the DCA 520. In some embodiments, the device 850 is implemented as a dedicate circuit (e.g., an application-specific integrated circuit) or a device. In some embodiments, the device 850 is implemented in a device with one or more processors and memory.

The device 850 includes receivers 802 and 804, cost estimator 812, and cost selector 832, described above with respect to FIG. 8A. In some embodiments, the device 850 also includes cost refiner 822.

In addition, the device 850 includes confidence estimator 860 (which may correspond to confidence estimator 620). The confidence estimator 860 receives the stereo matching difference profile from cost estimator 812 or cost refiner 822, and determines a confidence value by applying a predefined classifier to the received stereo matching difference profile. Thus, with the device 850, the confidence value may be obtained without cost estimator 814 and cost refiner 824. As a result, the device 850 may be made more compact than the device 800, and the device 850 may run more energy-efficiently than the device 800.

FIG. 8C illustrates components of a device 870 includes both confidence estimator 840 and the confidence estimator 860, in accordance with some embodiments. In some embodiments, the confidence values obtained from confidence estimator 840 and confidence estimator 860 are combined for filtering depth information (e.g., as shown in FIG. 7C).

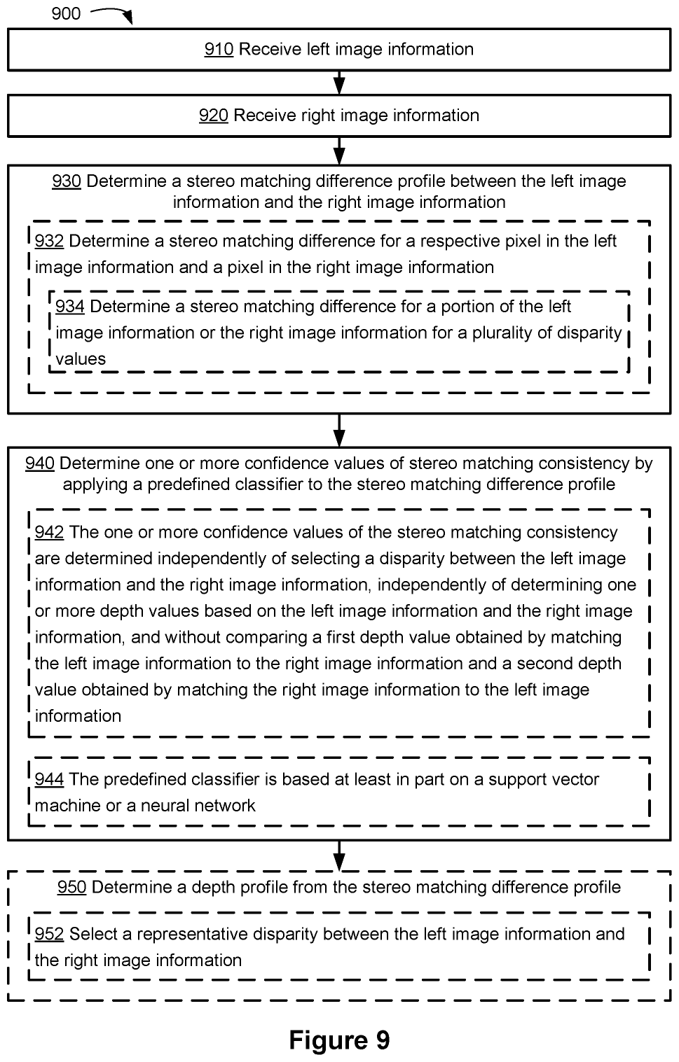

FIG. 9 is a flow diagram illustrating a method of determining confidence in stereo matching in accordance with some embodiments.

Method 900 includes (910) receiving left image information and (920) receiving right image information.

Method 900 also includes (930) determining a stereo matching difference profile between the left image information and the right image information.

Method 900 further includes (940) determining one or more confidence values of stereo matching consistency by applying a predefined classifier to the stereo matching difference profile.

In some embodiments, the one or more confidence values of the stereo matching consistency are determined (942) independently of selecting a disparity between the left image information and the right image information, independently of determining one or more depth values based on the left image information and the right image information, and/or without comparing a first depth value obtained by matching the left image information to the right image information and a second depth value obtained by matching the right image information to the left image information.

In some embodiments, the predefined classifier is based at least in part on a support vector machine.

In some embodiments, the predefined classifier is based at least in part on a neural network.

In some embodiments, determining the stereo matching difference profile includes (932) determining a stereo matching difference for a respective pixel in the left image information and a pixel in the right image information.

In some embodiments, determining the stereo matching difference profile also includes (934) determining a stereo matching difference for a portion of the left image information or the right image information for a plurality of disparity values.

In some embodiments, the method includes (950) determining a depth profile from the stereo matching difference profile.

In some embodiments, determining the depth profile from the stereo matching difference profile includes (952) selecting a representative disparity between the left image information and the right image information.

Some portions of this description describe the examples of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, and/or hardware.

Steps, operations, or processes described may be performed or implemented with one or more hardware or software modules, alone or in combination with other devices. In some examples, a software module is implemented with a computer program product comprising a computer-readable medium containing computer program code, which can be executed by a computer processor for performing any or all of the steps, operations, or processes described.

Examples of the disclosure may also relate to an apparatus for performing the operations described. The apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples of the disclosure may also relate to a product that is produced by a computing process described herein. Such a product may comprise information resulting from a computing process, where the information is stored on a non-transitory, tangible computer readable storage medium and may include any example of a computer program product or other data combination described herein.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the examples is intended to be illustrative, but not limiting, of the scope of the disclosure, which is set forth in the following claims.

What is claimed is:

1. A method of determining confidence in stereo matching, the method comprising:
receiving left image information;
receiving right image information;
determining a stereo matching difference profile between the left image information and the right image information; and
determining one or more confidence values of stereo matching consistency by applying a predefined classifier to the stereo matching difference profile.

2. The method of claim 1, wherein:
the one or more confidence values of the stereo matching consistency are determined independently of selecting a disparity between the left image information and the right image information.

3. The method of claim 1, wherein:
the one or more confidence values of the stereo matching consistency are determined independently of determining one or more depth values based on the left image information and the right image information.

4. The method of claim 1, wherein:
the one or more confidence values of the stereo matching consistency are determined without comparing a first depth value obtained by matching the left image information to the right image information and a second depth value obtained by matching the right image information to the left image information.

5. The method of claim 1, wherein:
the predefined classifier is based at least in part on a support vector machine.

6. The method of claim 1, wherein:
the predefined classifier is based at least in part on a neural network.

7. The method of claim 1, wherein:
determining the stereo matching difference profile includes determining a stereo matching difference for a respective pixel in the left image information and a pixel in the right image information.

8. The method of claim 1, wherein:
determining the stereo matching difference profile also includes determining a stereo matching difference for a portion of the left image information or the right image information for a plurality of disparity values.

9. The method of claim 1, further comprising:
determining a depth profile from the stereo matching difference profile.

10. The method of claim 9, wherein:
determining the depth profile from the stereo matching difference profile includes selecting a representative disparity between the left image information and the right image information.

11. An electronic device, comprising:
one or more processors; and
memory storing instructions for execution by the one or more processors, the stored instructions including instructions for:
receiving left image information;
receiving right image information;
determining a stereo matching difference profile between the left image information and the right image information; and
determining one or more confidence values of stereo matching consistency by applying a predefined classifier to the stereo matching difference profile.

12. The device of claim 11, wherein:
the instructions for determining the one or more confidence values of the stereo matching consistency are independent of instructions for selecting a disparity between the left image information and the right image information.

13. The device of claim 11, wherein:
the instructions for determining the one or more confidence values of the stereo matching consistency are independent of instructions for determining a depth based on the left image information and the right image information.

14. The device of claim 11, wherein:
the instructions for determining the one or more confidence values of the stereo matching consistency are independent of instructions for comparing a first depth obtained by matching the left image information to the right image information and a second depth obtained by matching the right image information to the left image information.

15. The device of claim 11, wherein:
the predefined classifier is based at least in part on a support vector machine.

16. The device of claim 11, wherein:
the predefined classifier is based at least in part on a neural network.

17. The device of claim 11, wherein:
determining the stereo matching difference profile includes determining a stereo matching difference for a respective pixel in the left image information or the right image information.

18. The device of claim 11, wherein:
determining the stereo matching difference profile also includes determining a stereo matching difference for a portion of the left image information or the right image information for a plurality of disparity values.

19. The device of claim 11, wherein the stored instructions also include instructions for:
determining a depth profile from the stereo matching difference profile.

20. A computer readable storage medium storing instructions, which, when executed by one or more processors of an electronic device, cause the electronic device to:
receive left image information;
receive right image information;
determine a stereo matching difference profile between the left image information and the right image information; and
determine one or more confidence values of stereo matching consistency by applying a predefined classifier to the stereo matching difference profile.
